(19) United States
(12) Patent Application Publication
(10) Pub. No.: US 2014/0310481 A1
(43) Pub. Date: Oct. 16, 2014

(54) MEMORY SYSTEM

(71) Applicant: SAMSUNG ELECTRONICS CO., LTD., Suwon-si (KR)

(72) Inventors: Hoi Ju CHUNG, Yongin-si (KR); Su A KIM, Seongnam-si (KR); Chul Woo PARK, Yongin-si (KR); Hak Soo YU, Seongnam-si (KR); Jae Youn YOUN, Seoul (KR); Jung Bae LEE, Seongnam-si (KR); Hyo Jin CHOI, Suwon-si (KR)

(73) Assignee: SAMSUNG ELECTRONICS CO., LTD., Suwon-si (KR)

(21) Appl. No.: 14/248,779

(22) Filed: Apr. 9, 2014

(30) Foreign Application Priority Data
Apr. 11, 2013 (KR) 10-2013-0040123

(51) Int. Cl. G06F 13/16

(52) U.S. Cl. CPC G06F 13/161; G06F 13/1657
USPC 711/148

(57) ABSTRACT

A memory system includes a memory controller to control a first memory device and a second memory device. The first and second memory devices are different in terms of at least one of physical distance from the memory controller, a manner of connection to the memory controller, error correction capability, or memory supply voltage. The first and second memory devices also have different latencies.

### CROSS-REFERENCE TO RELATED APPLICATION

Korean Patent Application No. 10-2013-0040123, filed on Apr. 11, 2013, and entitled, “Memory System,” is incorporated by reference herein in its entirety.

### BACKGROUND

1. Field

One or more embodiments described herein relate to a memory.

2. Description of the Related Art

A variety of memory systems have been developed. One type of memory system includes a plurality of memory devices, a memory controller, and a processing unit. The processing unit may be a central processing unit (CPU) or a graphic processing unit (GPU). If the processing unit is a type which performs multi-thread operations, synchronization overhead may increase.

One type of synchronization overhead involves an increased time cost for executing a mechanism to regulate access of data stored in the memory devices. The increased time cost may be especially pronounced in a system in which memory devices are to be controlled separately. In order to separately control the memory devices, the memory devices must first be distinguished from one another.

### SUMMARY

In accordance with one embodiment, a memory system includes a first memory device; a second memory device; and a memory controller to control the first and second memory devices, wherein the first and second memory devices are different from one another by at least one of physical distance from the memory controller, a manner of connection to the memory controller, error correction capability, or memory supply voltage, and wherein the first and second memory devices have different latencies.

Also, a latency of the first memory device is lower than a latency of the second memory device, when the first memory device is physically closer to the memory controller than the second memory device.

Also, a latency of the first memory device is lower than a latency of the second memory device, when the first memory device is connected to the memory controller through a vertical electrical connector and the second memory device is connected to the memory controller through a wire bond.

Also, a latency of the first memory device is lower than a latency of the second memory device, when the error correction capability of the first memory device is lower than the error correction capability of the second memory device.

Also, a latency of the first memory device is lower than a latency of the second memory device, when a memory supply voltage of the first memory device is higher than a memory supply voltage of the second memory device.

Also, bits of mode registers of the first memory device are set such that a read latency of the first memory device has an M (M is a natural number)-clock cycle, and bits of mode registers of the second memory device are set such that a read latency of the second memory device is N (N is a natural number greater than M)-clock cycle.

Also, the system includes a first fully-buffered dual in-line memory module (FBDIMM) which includes the first memory device, and a second FBDIMM including the second memory device.

Also, the system further includes a first unbuffered DIMM (UDIMM) which includes the first memory device, and a second UDIMM which includes the second memory device.

Also, the system includes a first load-reduced DIMM (LRDIMM) which includes the first memory device, and a second LRDIMM which includes the second memory device.

Also, the system is coupled to a portable electronic device.

In accordance with another embodiment, a memory system includes a first memory sub-system including at least one first memory device; a second memory sub-system including at least one second memory device; and a memory controller to control the first memory device and the second memory device, wherein the access time of the first memory device is faster than the access time of the second memory device, when the first memory device is physically closer to the memory controller than the second memory device.

Also, a latency of the first memory device is lower than a latency of the second memory device, when an error correction capability of the first memory device is lower than the error correction capability of the second memory device.

Also, each of the first sub-memory system and the second sub-memory system is a fully-buffered dual in-line memory module (FBDIMM).

Also, each of the first sub-memory system and the second sub-memory system is a load-reduced DIMM (LRDIMM).

In accordance with another embodiment, an electronic device includes a processor; and a memory system coupled to the processor and including: a first memory device; a second memory device; and a memory controller to control the first and second memory devices, wherein the first memory device has a first latency and the second memory device has a second latency different from the first latency.

Also, the first memory device at a first distance from the memory controller and the second memory device is at a second distance from the memory controller; and a difference in the first and second latencies is based on a difference between the first and second distances.

Also, the first memory device is connected to the memory controller by a first type of connector and the second memory device is connected to the memory controller by a second type of connector different from the first type of connector, and a difference in the first and second latencies is based on the different first and second types of connectors.

Also, the first memory device has a first error correction capability and the second memory device has a second error correction capability different from the first error correction capability, and a difference in the first and second latencies is based on the different first and second error correction capabilities.

Also, the first memory device operates based on a first supply voltage and the second memory device operates based on a second supply voltage different from the first supply voltage, and a difference in the first and second latencies is based on a difference between the first and second supply voltages.

Also, bits of mode registers of the first memory device are set such that a read latency of the first memory device has an M (M is a natural number)-clock cycle, and bits of mode registers of the second memory device are set such that a read latency of the second memory device is N (N is a natural number greater than M)-clock cycle.

### BRIEF DESCRIPTION OF THE DRAWINGS

Features will become apparent to those of ordinary skill in the art by describing in detail exemplary embodiments with reference to the attached drawings in which:

FIG. 1 illustrates an embodiment of a memory system;

FIG. 2 illustrates another embodiment of a memory system;

FIG. 3 illustrates another embodiment of a memory system;

FIG. 4 illustrates another embodiment of a memory system;

FIG. 5 illustrates another embodiment of a memory system;

FIG. 6 illustrates another embodiment of a memory system;

FIG. 7 illustrates another embodiment of a memory system;

FIG. 8 illustrates another embodiment of a memory system; and

FIG. 9 illustrates another embodiment of a memory system.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

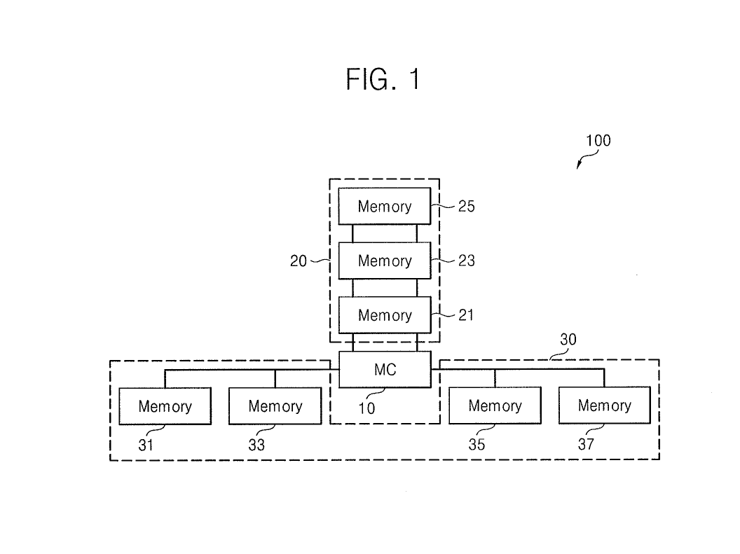

FIG. 1 illustrates one embodiment of a memory system 100 which includes a memory controller 10 and a plurality of memory devices 21, 23, 25, 31, 33, 35, and 37. The system may be included, for example, in a portable electronic device, a computer, or a data server. The portable electronic device may be included in a laptop computer, a net book, a mobile phone, a smart phone, a tablet PC, or a mobile internet device (MID), to name a few examples.

The memory devices 21, 23, 25, 31, 33, 35, and 37 may be volatile memory devices such as dynamic random access memories (DRAMs), static random access memories (SRAMs), Rambus DRAMs (RDRAMs), thyristor RAMs (T-RAMs), zero capacitor RAMs (Z-RAMs), or Twin Transistor RAMs (TTRAMs). In other embodiments, the memory devices 21, 23, 25, 31, 33, 35, and 37 may be non-volatile memory devices such as electrically erasable programmable read-only memories (EEPROMs), flash memories, magnetic RAMs (MRAMs), spin transfer torque MRAMs (STT-MRAMs), Conductive bridging RAMs (CBRAMs), ferroelectric RAMs (FeRAMs), phase change RAMs (PRAMs), nanotube RRAMs, polymer RAMs (PoRAMs), nano floating gate memories (NFGMs), holographic memories, molecular electronics memory devices, or insulator resistance change memories.

The memory controller 10 controls the plurality of memory devices 21, 23, 25, 31, 33, 35, and 37. For example, the memory controller 10 transfers read commands and addresses to the plurality of memory devices 21, 23, 25, 31, 33, 35, and 37, and receives data from the plurality of memory devices 21, 23, 25, 31, 33, 35, and 37. Also, the memory controller 10 transfers write commands, addresses, and data to the plurality of memory devices 21, 23, 25, 31, 33, 35, and 37.

As shown in FIG. 1, memory system 100 is divided into a first memory sub-system 20 and a second memory sub-system 30 based on the connection relationship of the memory controller 10 with memory devices 21, 23, 25, 31, 33, 35, and 37.

The first memory sub-system 20 includes memory devices 21, 23, and 25, and the second memory sub-system 30 includes memory devices 31, 33, 35, and 37. The memory controller and the memory devices 21, 23, and 25 may be connected to one another, for example, using vertical electrical connectors, e.g., a Through Silicon Via (TSV).

The memory devices 21, 23, and 25 are stacked on the memory controller 10. The memory controller 10 transfers commands, addresses, and data to the memory devices 21, 23, and 25, and receives data from the memory devices 21, 23, and 25 through the vertical electrical connectors.

The memory devices 31, 33, 35, and 37 may be connected to the memory controller 10 using various types of connections. For example, the memory controller 10 may be connected to the memory devices 31, 33, 35, and 37 using a wire bonding method. The memory controller 10 may transfer commands, addresses, and/or data to memory devices 31, 33, 35, and 37, and may receive data from these memory devices, through wires. In another embodiment, the memory controller 10 may be connected to the memory devices 31, 33, 35, and 37 by a flip-chip method.

The access times of memory devices 21, 23, 25, 31, 33, 35, and 37 may be set to be different from one another. For example, the access time(s) of memory devices 21, 23, and 25 may be faster than the access time(s) of memory devices 31, 33, 35, and 37. In one embodiment, the access time may be understood to mean the time cost (e.g., amount of time) until valid data is output from respective ones of the memory devices 21, 23, 25, 31, 33, 35, or 37 or the time until valid data becomes available.

For example, the latencies of memory devices 21, 23, 25, 31, 33, 35, and 37 may be set so that latencies of memory devices 21, 23, and 25 are lower than latencies of memory devices 31, 33, 35, and 37. In one embodiment, latency may be understood to mean the time cost of transmitting data output from memory devices 21, 23, 25, 31, 33, 35, or 37 to the memory controller 10 or to another device or through a predetermined signal path.

More specifically, bits of each mode register of the memory devices 21, 23, and 25 may be set such that a read latency of each of the memory devices 21, 23, and 25 has an M (M is a natural number)-clock cycle. Bits of each mode register of the memory devices 31, 33, 35, and 37 may be set such that a read latency of each of the plurality of memory devices 31, 33, 35, and 37 has an N (N is a natural number larger than M)-clock cycle.

Also, bits of each mode register of the memory devices 21, 23, and 25 in the first memory sub-system 20 and bits of each mode register of the memory devices 31, 33, 35, and 37 in the second memory sub-system may be set such that the first memory sub-system 20 and the second memory sub-system 30 have different latencies. This may have the effect of reducing synchronization overhead. The mode register may denote a mode register set (MRS).

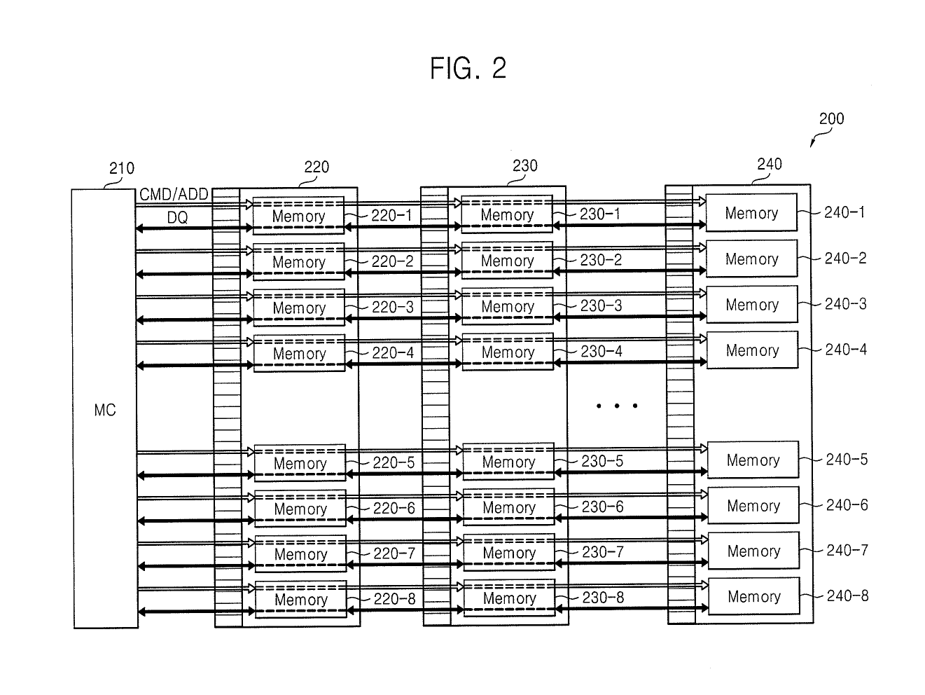

FIG. 2 illustrates another embodiment of a memory system 200, which, for example, may be included in a portable electronic device, a computer, or a data server, as previously discussed. The memory system 200 includes a memory controller 210 and a plurality of unbuffered dual in-line memory module (UDIMMs) 220, 230, and 240.

Each of the plurality of UDIMMs 220, 230, and 240 includes a plurality of memory devices 220-1 to 220-8, 230-1 to 230-8, and 240-1 to 240-8.

The memory controller 210 transfers commands CMD and addresses ADD to the memory devices 220-1 to 220-8, 230-1 to 230-8, and 240-1 to 240-8 and receives data DQ from the memory devices 220-1 to 220-8, 230-1 to 230-8, and 240-1 to 240-8. The memory controller 210 transfers data DQ to the memory devices 220-1 to 220-8, 230-1 to 230-8, and 240-1 to 240-8. Each of the memory devices 220-1 to 220-8, 230-1 to 230-8, and 240-1 to 240-8 may be included, for example, in a volatile memory such as DRAM.

The memory system 200 is divided into a first memory sub-system and a second memory sub-system according to physical distance between the plurality of UDIMMs 220, 230, and 240 and a memory controller 210. For example, the memory devices 220-1 to 220-8, 230-1 to 230-8, or 240-1 to 240-8 may be arranged or defined such that a first UDIMM 220 and a second UDIMM 230 are in the first memory sub-system, and a third UDIMM 240 is in the second memory sub-system.

In one embodiment, bits of each mode register of the memory devices 220-1 to 220-8, 230-1 to 230-8 are set such that a read latency of the plurality of memory devices 220-1 to 220-8 and 230-1 to 230-8 in the first sub-system has an M (M is a natural number)-clock cycle. Bits of each mode register of memory devices 240-1 to 240-8 are set such that a read latency of the plurality of memory device 240-1 to 240-8 in the second memory sub-system has an N (N is a natural number larger than M)-clock cycle. That is, each of the memory devices 220-1 to 220-8 and 230-1 to 230-8 in the first UDIMM 220 and the second UDIMM 230 have a first latency, and the memory devices 240-1 to 240-8 in the third UDIMM 240 have a second latency. Because the first memory sub-system and the second sub-system are configured to have different latencies, synchronization overhead may be reduced.

In another embodiment, the first UDIMM 220 is in the first memory system, and the second UDIMM 230 and the third UDIMM 240 are in the second sub-memory system. Memory devices 220-1 to 220-8 in the first UDIMM 220 may have a first latency, and memory devices 230-1 to 230-8 in the second UDIMM 230 and the third UDIMM 240 may have a second latency. In some embodiments, the number of UDIMMs and memory devices each UDIMM may be varied, including as few as one.

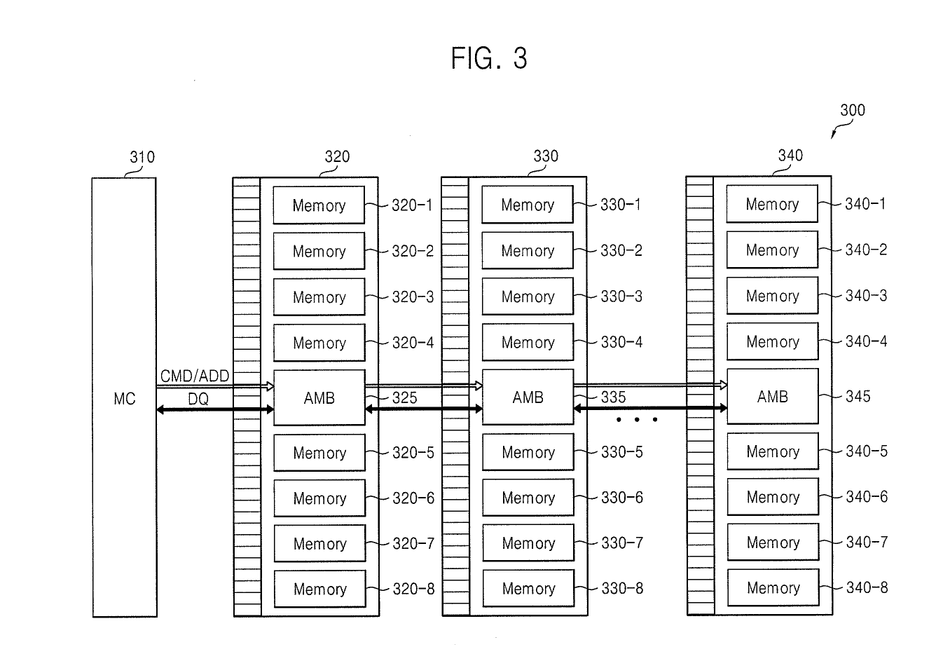

FIG. 3 illustrates another embodiment of a memory system 300, which, for example, may be included in a portable electronic device, a computer, or a data server. s illustrated in FIG. 3, memory system 300 includes a memory controller 310 and a plurality of fully-buffered dual in-line memory modules (FBDIMMs) 320, 330, and 340.

Each of the FBDIMMs 320, 330, and 340 may include an advanced memory buffer 325, 335, or 345, and a plurality of memory devices 320-1 to 320-8, 330-1 to 330-8, and 340-1 to 340-8, respectively.

The advanced memory buffers 325, 335, or 345 are memory interfaces connecting respective ones of the plurality of memory devices 320-1 to 320-8, 330-1 to 330-8, and 340-1 to 340-8 to the memory controller 310. Each of the advanced memory buffers 325, 335, and 345 receives commands CMD and addresses ADD from the memory controller 310, transfers data DQ to the memory controller 310, and/or receives data DQ from the memory controller 310. Each of the memory devices 320-1 to 320-8, 330-1 to 330-8, and 340-1 to 340-8 may be, for example, volatile memory devices such as DRAMs.

The memory system 300 may be divided into a first memory sub-system and a second memory sub-system according to physical distance between the plurality of FBDIMMs 320, 330, and 340 and the memory controller 310. For example, each of the plurality of 320-1 to 320-8, 330-1 to 330-8, and 340-1 to 340-8 may be arranged or defined such that the first FBDIMM 320 and the second FBDIMM 330 are in the first memory sub-system and the third FBDIMM 340 is in the second memory sub-system.

In one embodiment, bits of each mode register of the memory devices 320-1 to 320-8 and 330-1 to 330-8 may be set such that a read latency of memory devices 320-1 to 320-8 and 330-1 to 330-8 has an M-clock cycle. Bits of each mode register of memory devices 340-1 to 340-8 may be set such that a read latency of each of memory devices 340-1 to 340-8 has an N (N is a natural number greater than M)-clock cycle. That is, each of the memory devices 320-1 to 320-8 and 330-1 to 330-8 may have a first latency, and each of the memory devices 340-1 to 340-8 may have a second latency. Thus, each of the first memory sub-system and the second memory sub-system may have a different latency, thereby reducing synchronization overhead.

In some embodiments, the first FBDIMM 320 may be in the first memory sub-system, and the second FBDIMM 330 and the third FBDIMM 340 may be in the second memory sub-system. Each of the memory devices 320-1 to 320-8 in the first FBDIMM 320 may have a first latency, and each of the memory devices 330-1 to 330-8 and 340-1 to 340-8 in the second FBDIMM 330 and the third FBDIMM 340 may have a second latency. The number of FBDIMMs and the number of the memory devices in each of the FBDIMMs may be varied, including as few as one.

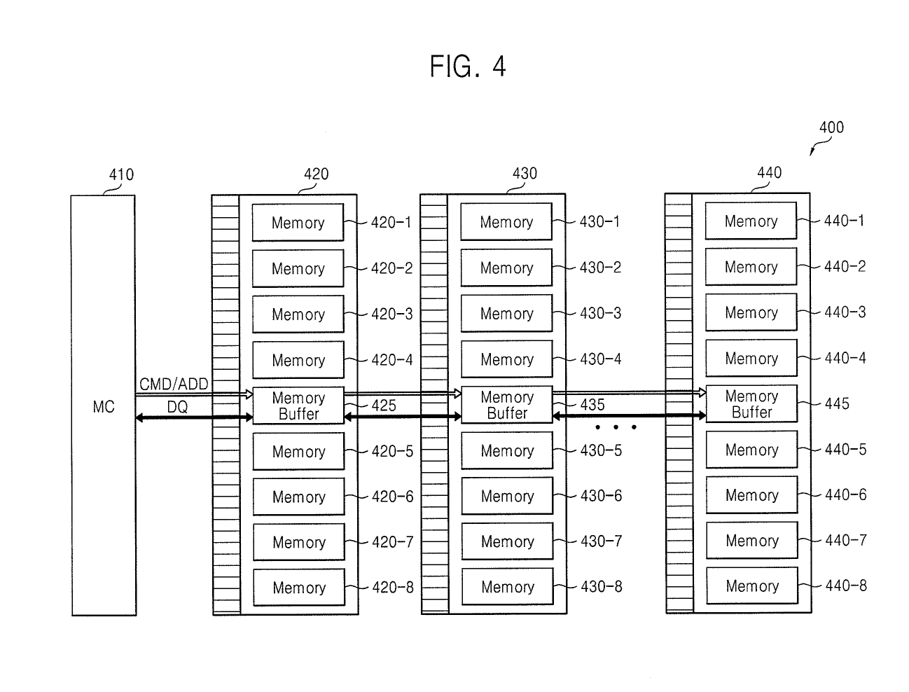

FIG. 4 illustrates another embodiment of a memory system 400, which, for example, may be included in a portable electronic device, a computer, or a data server. The memory system 400 includes a memory controller 410 and a plurality of load-reduced dual in-line memory modules (LRDIMMs) 420, 430, and 440.

Each LRDIMM 420, 430, and 440 includes a respective memory buffer 425, 435, or 445, and a respective plurality of memory devices 420-1 to 420-8, 430-1 to 430-8, and 440-1 to 440-8. The memory buffers 425, 435, and 445 receive commands CMD and addresses ADD from the memory controller 410, transmit data DQ thereto, and/or receive data DQ therefrom. Each memory device 420-1 to 420-8, 430-1 to 430-8, and 440-1 to 440-8 may be, for example, a volatile memory such as DRAM.

The memory system 400 is divided into a first memory sub-system and a second memory sub-system according to physical distance between the memory controller 410 and the plurality of LRDIMMs 420, 430, and 440. For example, memory devices 420-1 to 420-8, 430-1 to 430-8, and 440-1 to 440-8 may be arranged or defined such that the first LRDIMM 420 and the second LRDIMM 430 are in the first memory sub-system, and the third LRDIMM 340 is in the second memory sub-system.

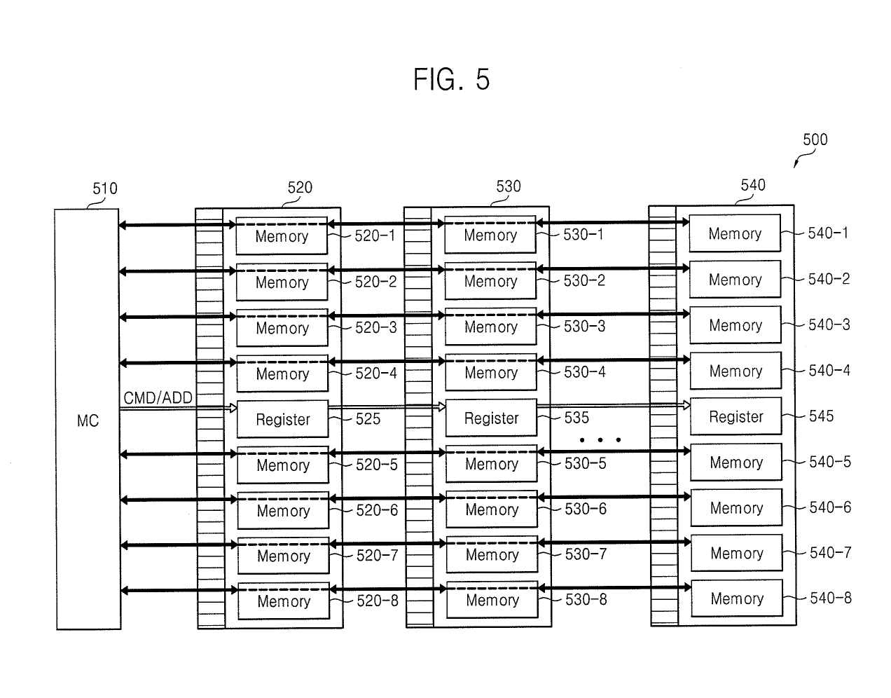

FIG. 5 illustrates another embodiment of memory system 500, which, for example, may be included in a portable device, a computer, or a data server. The memory system 500 includes a memory controller 510 and a plurality of registered dual in-line memory module (RDIMMs) 520, 530, and 540.

The RDIMMs 520, 530, and 540 include respective registers 525, 535, or 545, and a respective plurality of memory devices 520-1 to 520-8, 530-1 to 530-8, and 540-1 to 540-8. Registers 525, 535, and 545 receive commands CMD and addresses ADD from the memory controller 510. Memory devices 520-1 to 520-8, 530-1 to 530-8, and 540-1 to 540-8 transfer data DQ to the memory controller 510 and/or receive data DQ therefrom. Memory devices 520-1 to 520-8, 530-1 to 530-8, and 540-1 to 540-8 may be, for example, a volatile memory such as DRAM.

The memory system 500 is divided into a first memory sub-system and a second memory sub-system according to physical distance between the memory controller 510 and the plurality of RDIMMs 520, 530, and 540. For example, memory devices 520-1 to 520-8, 530-1 to 530-8, and 540-1 to 540-8 may be set such that the first RDIMM 520 and the second RDIMM 530 are in the first memory sub-system, and the third RDIMM 540 is in the second memory sub-system. Similarly to FIG. 3, a latency of each of the plurality of memory devices in the first and second memory sub-systems may have different latencies.

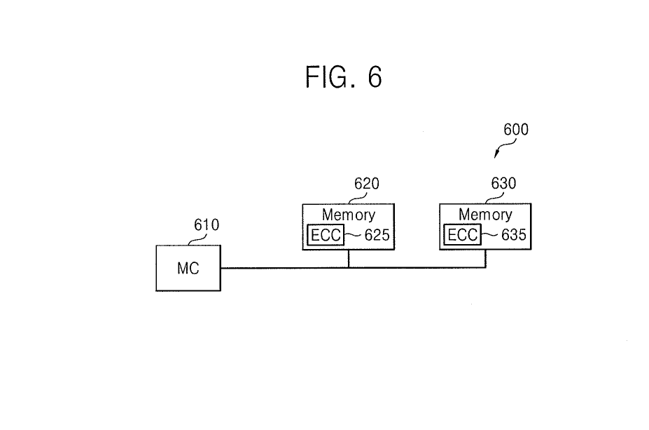

FIG. 6 illustrates another embodiment of a memory system 600, which, for example, may be included in a portable electronic device, a computer, or a data server. The memory system 600 includes a memory controller 610 and a plurality of memory devices 620 and 630. The memory controller 610 controls the plurality of memory devices 620 and 630. The memory devices 620 and 630 may be, for example, a volatile memory device such as DRAM or a non-volatile memory device such as flash memory.

The memory system 600 includes a first sub-memory system including the first memory device 620 and a second sub-memory system including the second memory device 630. The memory devices 620 and 630 include error correction coding blocks 625 and 635, respectively. Each memory device 620 and 630 may be distinct according to the error correction capability.

The memory devices 620 and 630 may be set or defined such that a latency of the first memory device 620 is lower than a latency of the second memory device 630, when the error correction capability of the first memory device 620 is lower than the error correction capability of the second memory device 630. For example, the memory devices 620 and 630 may be set or defined such that a latency of the first memory device 620 is lower than a latency of the second memory device 630, where or when the first error correction coding block 625 may correct a k-bit error, and the second error correction coding block 635 may correct j-bit or more errors. The values k and j may be 1 and 2, respectively, or may be different numbers.

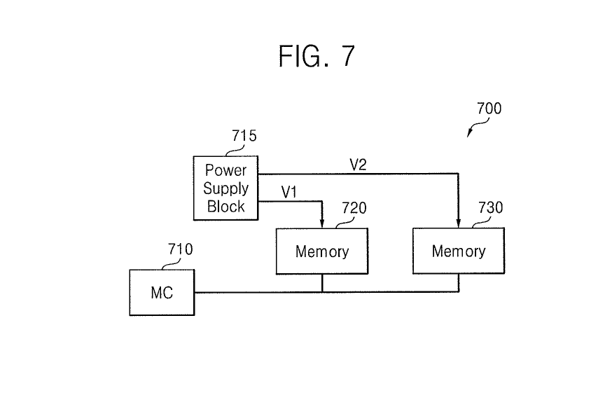

FIG. 7 illustrates another embodiment of a memory system 700, which, for example, may be included in portable electronic device, a computer, or a data server. The memory system 700 includes a memory controller 710, a power supply block 715, and a plurality of memory devices 720 and 730. The memory controller 710 controls the plurality of memory devices 720 and 730.

The power supply block 715 provides memory supply voltages V1 and V2 to respective ones of memory devices 720 and 730. The memory devices 720 and 730 may be, for example, a volatile memory device such as DRAM or a non-volatile memory device such as flash memory.

The memory devices 720 and 730 may be distinct from each other based on the memory supply voltages V1 and V2 supplied by the power supply block 715. That is, the memory system 700 may be divided into a first sub-memory system including the first memory device 720 and a second sub-memory system including the second memory device 730 according to each of the memory supply voltages V1 and V2. In one embodiment, the voltages V1 and V2 are different from one another.

The memory devices 720 and 730 may be set or defined to have different latencies. In one embodiment, bits of the mode register of each memory device 720 and 730 may be set so that a latency of the first memory device 720 is lower than a latency of the second memory device 730, when the memory supply voltage V1 of the first memory device 720 is higher than the memory supply voltage V2 of the second memory device 730.

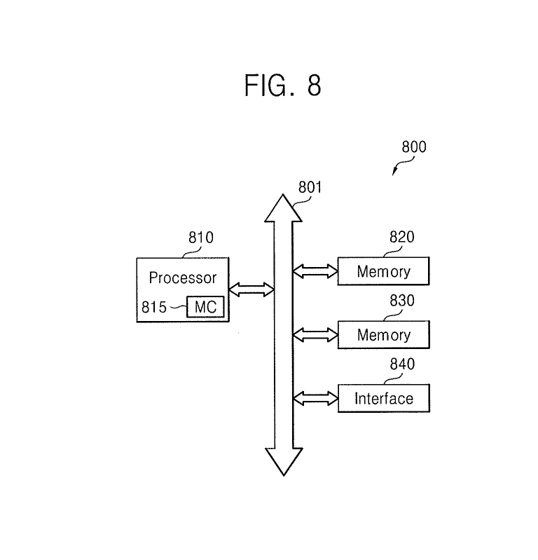

FIG. 8 illustrates another embodiment of a memory system 800, which, for example, may be included in a server, a personal computer (PC), or a computer. The memory system 800 includes a processor 810, a plurality of memory devices 820 and 830, and an interface 840. The processor, memory devices, and interface may communicate with each other through a bus 801.

The processor 810 controls at least one operation of memory devices 820 and 830 and interface 840. The processor 810 includes a memory controller 815 for controlling the memory devices 820 and 830. The first memory device 820 and the second memory device 830 may be, for example, a volatile memory device such as DRAM or a non-volatile memory device such as flash memory.

The first memory device 820 and the second memory device 830 may be different from one another based on one or more of physical distance from the memory controller 815, a manner of connection to the memory controller, error correction capability, or a memory supply voltage.

The information indicative of the aforementioned difference(s) may be stored in a mode register or a mode register set. For example, the memory system 800 may be divided into a first memory sub-system including the first memory device 820 and a second memory sub-system including the second memory device 830 according to at least one of physical distance with the memory controller 815, connection relation, the error correction capability, or a memory supply voltage.

The first and second memory devices 820 and 830 may be set to have different latencies with each other. Accordingly, synchronization overhead may be reduced.

In one embodiment, the interface 840 is an output device such as display or printer, or an input device such as touch screen, mouse, or keyboard. Alternatively, the interface 840 may be a wireless communication interface capable of performing wireless communication with an exterior computer system.

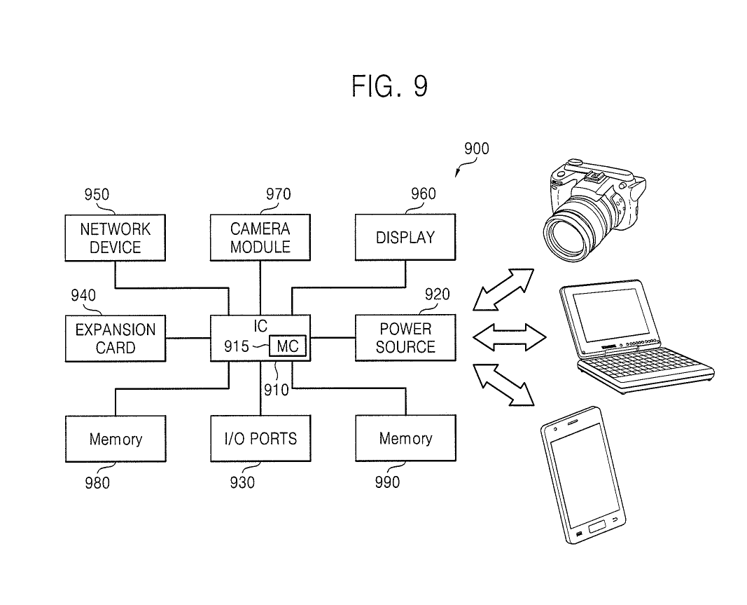

FIG. 9 illustrates another embodiment of a memory system 900 included in a portable electronic device such as digital camera, cell phone, smart phone, tablet PC, or mobile internet device. The memory system 900 includes an integrated circuit 910, a power source 920, input/output ports 930, an extension card 940, a network device 950, a display 960, and a plurality of memory devices 980 and 990.

The memory system 900 further includes a camera module 970. The integrated circuit 910 controls at least one operation of the components 920 to 970. The integrated circuit 910 may be, for example, a processor, a system on chip (SoC), an application processor, or a mobile application processor.

The integrated circuit 910 includes a memory controller 915 for controlling memory devices 980 and 990. In another embodiment, the memory controller 915 may be outside and coupled to the integrated circuit 910.

The power source 920 provides an operation voltage to at least one of the components 910 and 930 to 990. The input/output ports 930 denotes ports that are capable of transmitting data to the memory system 900 or transmitting data output from the memory system 900 to an exterior device.

The extension card 940 may be a secure digital (SD) card or a multimedia (MMC) card. For example, the extension card 940 may be a Subscriber Identification Module (SIM) card or a Universal Subscriber Identity Module (USIM) card.

The network device 950 may be a device capable of connecting the memory system 900 to a network, including but not limited to a wireless network. The display 960 displays data output from the input/output ports 930, the extension card 940, and/or the network device 950.

The camera module 970 denotes a module capable of converting an optical image to an electrical image. Thus, an electrical image output from the camera module 970 is stored in the integrated circuit 910 or the extension card 940. Also, the electrical image output from the camera module 970 is displayed through the display 960 under the control of the integrated circuit 910.

The first memory device 980 and the second memory device 990 may be a volatile memory device such as DRAM or a non-volatile memory device such as flash memory. The first memory device 980 and the second memory device 990 may be different from one another by at least one of physical distance with the memory controller 915, manner of connection to the memory controller 915, error correction capability, or a memory supply voltage.

The memory system 900 may be divided into a first memory sub-system including the first memory device 980 and a second memory sub-system including the second memory device 990, according to at least one of physical distance with the memory controller 915, connecting relation therewith, the error correction capability, and a memory supply voltage.

Each mode register or mode register of each of the memory device 980 and 990 may be set to have different latencies with each other, thereby reducing synchronization overhead.

In accordance with one or more embodiments, synchronization overhead may be reduced by dividing a memory system into memory sub-systems which have different latencies with each other.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A memory system comprising:
a first memory device;
a second memory device; and
a memory controller to control the first and second memory devices,
wherein the first and second memory devices are different from one another by at least one of physical distance from the memory controller, a manner of connection to the memory controller, error correction capability, or memory supply voltage, and wherein the first and second memory devices have different latencies.

2. The memory system as claimed in claim 1, wherein a latency of the first memory device is lower than a latency of the second memory device, when the first memory device is physically closer to the memory controller than the second memory device.

3. The memory system as claimed in claim 1, wherein a latency of the first memory device is lower than a latency of the second memory device, when the first memory device is connected to the memory controller through a vertical electrical connector and the second memory device is connected to the memory controller through a wire bond.

4. The memory system as claimed in claim 1, wherein a latency of the first memory device is lower than a latency of the second memory device, when the error correction capability of the first memory device is lower than the error correction capability of the second memory device.

5. The memory system as claimed in claim 1, wherein a latency of the first memory device is lower than a latency of the second memory device, when a memory supply voltage of the first memory device is higher than a memory supply voltage of the second memory device.

6. The memory system as claimed in claim 1, wherein:
bits of mode registers of the first memory device are set such that a read latency of the first memory device has an M (M is a natural number)-clock cycle, and
bits of mode registers of the second memory device are set such that a read latency of the second memory device is N (N is a natural number greater than M)-clock cycle.

7. The memory system as claimed in claim 1, further comprising:
a first fully-buffered dual in-line memory module (FBDIMM) which includes the first memory device, and
a second FBDIMM including the second memory device.

8. The memory system as claimed in claim 1, further comprising:
a first unbuffered DIMM (UDIMM) which includes the first memory device, and
a second UDIMM which includes the second memory device.

9. The memory system as claimed in claim 1, further comprising:
a first load-reduced DIMM (LRDIMM) which includes the first memory device, and a second LRDIMM which includes the second memory device.

10. The memory system as claimed in claim 1, wherein the memory system is coupled to a portable electronic device.

11. A memory system comprising:
a first memory sub-system including at least one first memory device;
a second memory sub-system including at least one second memory device; and
a memory controller to control the first memory device and the second memory device, wherein the access time of the first memory device is faster than the access time of the second memory device, when the first memory device is physically closer to the memory controller than the second memory device.

12. The memory system as claimed in claim 11, wherein a latency of the first memory device is lower than a latency of the second memory device, when an error correction capability of the first memory device is lower than the error correction capability of the second memory device.

13. The memory system as claimed in claim 12, wherein each of the first sub-memory system and the second sub-memory system is a fully-buffered dual in-line memory module (FBDIMM).

14. The memory system as claimed in claim 13, wherein each of the first sub-memory system and the second sub-memory system is a load-reduced DIMM (LRDIMM).

15. An electronic device, comprising:
a processor; and
a memory system coupled to the processor and including:
a first memory device;
a second memory device; and
a memory controller to control the first and second memory devices,
wherein the first memory device has a first latency and the second memory device has a second latency different from the first latency.

16. The electronic device as claimed in claim 15, wherein:
the first memory device at a first distance from the memory controller and the second memory device is at a second distance from the memory controller; and
a difference in the first and second latencies is based on a difference between the first and second distances.

17. The electronic device as claimed in claim 15, wherein:
the first memory device is connected to the memory controller by a first type of connector and the second memory device is connected to the memory controller by a second type of connector different from the first type of connector, and
a difference in the first and second latencies is based on the different first and second types of connectors.

18. The electronic device as claimed in claim 15, wherein:
the first memory device has a first error correction capability and the second memory device has a second error correction capability different from the first error correction capability, and
a difference in the first and second latencies is based on the different first and second error correction capabilities.

19. The electronic device as claimed in claim 15, wherein:
the first memory device operates based on a first supply voltage and the second memory device operates based on a second supply voltage different from the first supply voltage, and
a difference in the first and second latencies is based on a difference between the first and second supply voltages.

20. The electronic device as claimed in claim 15, wherein:
bits of mode registers of the first memory device are set such that a read latency of the first memory device has an M (M is a natural number)-clock cycle, and
bits of mode registers of the second memory device are set such that a read latency of the second memory device is N (N is a natural number greater than M)-clock cycle.
